(19) United States
(12) Patent Application Publication
(10) Pub. No.: US 2018/0086434 A1
(43) Pub. Date: Mar. 29, 2018

(54) An Aircraft for Aerial Delivery

(71) Applicant: George Michael Cook, Kent (GB)

(72) Inventors: George Michael Cook, Kent (GB); Jonathan Edward Cook, Kent (GB); Michael Kevin Cook, Kent (GB)

(21) Appl. No.: 15/567,585

(22) PCT Filed: Apr. 20, 2016
(86) PCT No.: PCT/GB2016/051085

§ 371 Date: Oct. 18, 2017

(30) Foreign Application Priority Data
Apr. 20, 2015 (GB) 1506670.7
Apr. 20, 2015 (GB) 1506671.5

(51) Int. Cl. B64C 13/28; B64C 3/56; B64C 1/06; B64C 31/02; B64C 39/02

(52) U.S. Cl. CPC B64C 13/28; B64C 3/56; B64C 2001/0054; B64C 31/02; B64C 39/024; B64C 1/061

(57) ABSTRACT

An aircraft for the autonomous aerial delivery of a load to a target location, the aircraft comprising an airframe having at least one adjustable control structure for controlling the flight of the aircraft and a main body adapted to receive a load a self-contained control module releaseably connected to the airframe, the control module containing an actuator for adjusting the control structure and a controller for producing an electrical drive signal for controlling the actuator; and at least one linkage extending from the control module to the at least one adjustable control structure so as to operably connect the control module to the at least one adjustable control structure, wherein the actuator of the control module is adapted to adjust the at least one adjustable control structure using the at least one linkage so as to control the flight of the aircraft and to steer the aircraft to the target location.

### FIELD OF INVENTION

The present invention relates to an aircraft, in particular an aircraft for the autonomous aerial delivery of a load to a target location.

### BACKGROUND TO THE INVENTION

Logistics is a fundamental part of any operation, whether humanitarian, commercial or military and vast sums of money are spent building infrastructure and delivering goods to remote or hard-to-reach locations. While many systems for delivery of goods have been developed, many, however, have numerous limitations.

Often the intended delivery site is either in a very remote location or in a hostile region, which means that delivery by land, for example via a convoy of vehicles, can be slow and/or dangerous. Furthermore, delivery by land is not always a viable option in regions where the terrain is impassable. The alternative, delivery by air, is an expensive method of delivering goods and requires either a suitable landing zone for an aircraft or requires the use of aerial delivery systems, such as air drops, to delivery goods. These limit the sites to which goods can be delivered and the aerial delivery methods are not always accurate. In some hostile regions, even aerial delivery is too dangerous, as the risk to life and the aircraft is too high.

Even in commercial operations, such as mining, it can be an onerous task to deliver goods to the remote sites on a frequent basis. Instead, operators often resort to infrequent (e.g. weekly) deliveries in which an aircraft will fly to a number of different sites in one trip. This is often costly and time consuming, as it will require flying to each site and landing/unloading.

Conventional aerial delivery systems or air drop systems generally comprise a platform onto which the goods are secured which is connected to a parachute. The platform will then be dropped from an aeroplane or helicopter above a target location, with the parachute slowing the descent of the package. The goods can subsequently be recovered at the target location. The limitations with such a system are that the goods often miss the target location and can end up landing in built-up areas or causing collateral damage. Furthermore, some common aerial delivery systems (such as low-altitude parachute extraction (LAPES)) require the aircraft to descend to low altitudes in order to deliver the goods. This is particularly risky in hostile environments, for example when a forward operating base is resupplied.

In many cases, aerial delivery systems are only used once as the recovery of parachutes and packaging can be too expensive or too dangerous to make recovery viable. This can add substantial cost to the cost of delivering goods by aerial delivery and make it an expensive method of transporting goods. This also has a substantial environmental impact as significant resources are not recovered or re-used and can damage or blight the environment. For example, the majority of parachutes are manufactured from nylon and the boxes or platforms in an aerial delivery system from plastic, wood or metal and, therefore, could be re-used multiple times if recovered.

Traditionally, aerial delivery systems are dropped from large aeroplanes, such as the widely used C-130 Hercules aeroplane, or helicopters. The use of the large aircraft greatly limits the situations where aerial delivery can be used and increases the costs of any such operation, due to the large associated costs and the relative scarcity of such aircraft outside of military use.

### SUMMARY OF THE INVENTION

According to the invention, there is provided an aircraft and method of use of an aircraft as defined in the independent claims.

A first aspect of the invention provides an aircraft for the autonomous aerial delivery of a load to a target location, in which the aircraft comprises an airframe having at least one adjustable control structure for controlling the flight of the aircraft and a main body adapted to receive a load, a self-contained control module releaseably connected to the airframe, the control module containing an actuator for adjusting the control structure and a controller for producing a drive signal for controlling the actuator; and at least one linkage extending from the control module to the at least one adjustable control structure so as to operably connect the control module to the at least one adjustable control structure, wherein the actuator of the control module is adapted to adjust the at least one adjustable control structure using the at least one linkage so as to control the flight of the aircraft and to steer the aircraft to the target location.

Embodiments of this invention therefore provide a means by which goods can be delivered to remote locations at low cost, and without needing to recover costly delivery aircraft or to install expensive landing facilities. In particular, embodiments of the invention provide an aircraft in which the airframe of the aircraft can be used for a single delivery and subsequently be disposed of (e.g. recycled, burnt) while the more expensive components, such as the electronic components and actuators, are contained in a removable control module (or control unit) and can therefore be re-used in another airframe.

This aircraft provides an aerial delivery system in which the airframe can be manufactured from cheap, disposable materials (such as cardboard) which can be discarded once the delivery has been made. Once delivered, a user can remove and recover the expensive and reusable electronic components of the aircraft and discard the airframe. In particular, the user can extract the control module by disconnecting the linkages and removing the self-contained unit as a single unit from the airframe. The linkages can be releaseably attached to the control module, such that the linkages remain attached to the airframe, or the linkages may be releaseably attached to the aircraft (such as to the control structures) such that the linkages can be removed from the airframe with the control module. Alternatively, or in addition, the linkages may have another point at which it detaches (e.g. along the length of the linkage) or it may be detachable at multiple points such that a user can determine whether the linkages are removed from the airframe. Thus, embodiments of the invention provide a delivery system in which the expensive components of the aircraft can be recycled, while the bulky parts of the aircraft can be formed from cheap and disposable materials, with the different parts of the aircraft being easily separable.

Such an aircraft can advantageously be utilised for a number of different delivery operations. In particular, the aircraft can be used to deliver goods to locations where access by land is limited and it is difficult and/or expensive to land an aeroplane at the location. For example, the aircraft (in particular, a plurality of the aircraft) can be launched from a single “launch aircraft” (i.e. a vehicle from which the aircraft according to the invention can be launched) (such as an aeroplane) and can automatically fly to a remote location in need of humanitarian aid. Once the aircraft has landed, the recipient can remove the goods from the aircraft, together with the control module. The control module can then be stored for future use, inserted into another airframe, or returned to the supplier, for example. The airframe can be disposed of in any suitable manner, preferably an environmentally friendly manner, such as by recycling or leaving the airframe to biodegrade, if biodegradable.

Embodiments thus have particular application in situations where storage is limited. For example, if personnel (e.g. on a humanitarian mission, a military mission or on a recreational expedition) are in a difficult-to-reach area and require resources, for example in an emergency, the aircraft can be used to supply the personnel with the goods they require. The control module and linkage arrangement together interact to provide an aircraft that can reach the target location (i.e. the personnel in this case) with pinpoint accuracy. Then, once the aircraft has delivered the goods, the recipient(s) can remove the expensive control module from the aircraft and carry this with them, while discarding the disposable airframe. Delivery in this embodiment is thus relatively inexpensive, since only the airframe is discarded. Moreover, compared to existing unmanned aerial devices, the airframe can be produced at a much lower cost than reusable airframes. This also removes any requirement for the personnel to return the aircraft, thus reducing the equipment the recipient has to return. Particularly in military situations, or regions in which there are hostile forces, delivery using an aircraft according to the invention has the additional advantages of reducing the risk that hostile forces will recover important electronic components, which can be reverse engineered, for example. Further, as the aircraft can be launched a significant distance from the target location, the risk to human operators of the aircraft is reduced, since they may not be required to fly over the hostile territory.

Additionally, the aircraft can be used in large-scale delivery operations, for example resupplying an outpost or operation (e.g. a mine). As embodiments of the aircraft provide a relatively low-cost delivery means, the devices can be used to reduce the costs of operating logistics networks. For example, resource harvesting operations, such as mining, are often located in remote regions. There can be a number of mines located over a vast area, with little infrastructure. Resupply of these operations will sometimes involve aerial delivery, which requires a delivery aircraft (e.g. a manned aeroplane) to fly directly to each of the operations (mines) and land at each location before unloading and taking off again. The infrastructure requirements and cost of this delivery can be reduced using embodiments of this invention since the aircraft can be launched directly from the delivery aircraft whilst it is in the air. Accordingly, the delivery aircraft no longer has to land at each of the sites, nor does it have to fly directly to each of the sites. Instead, it can release the aircraft of the invention whilst in flight and the control module will guide each of the aircraft to the site. Numerous aircraft according to the invention can be deployed at once. This reduces the fuel cost of the delivery aircraft, and reduces the time for delivery. This also eliminates the requirement for runways at each of the sites for the aircraft to land. Compared to delivery via a parachute, the aircraft of the invention provide a more accurate means of delivery, since the aircraft is guided, and this reduces the risk of damage to structures etc. on the site. Furthermore, the devices do not need to be released substantially above the target location and instead can be released a number of miles away from the target. Thus, in embodiments, this can dramatically reduce the cost of delivery of goods, for example by using numerous aircraft formed of cheap, disposable airframes to deliver goods simultaneously. This can also avoid the significant capital investment that would otherwise be required for numerous existing reusable unmanned aircraft, for example.

Embodiments of this aspect of the invention also provide an aircraft that can be used for autonomous aerial delivery, such that an operator can launch the aircraft and rely on the control module of the aircraft to guide the aircraft to its target location. The linkages which extend from the control module to the control structures serve to guide the aircraft in flight. By control structure it is meant any structure or part of the aircraft that is used to control the flight of the glider, for example the altitude of the glider or the direction in which the aircraft is flying and facing. In an embodiment, the control structure is a control surface. A control surface includes ailerons, elevators, rudders and any other surface that is used to control the flight of the aircraft by adjusting the altitude, roll, yaw and pitch of an aircraft, for example.

A linkage is a mechanical link that conveys kinetic energy, in this invention from the control module to its respective control structure. This may include, for example, a member, a plurality of members linked together and/or a length of cord or line (e.g. a wire, a rope, a thread). In other words, it is any object that can cause the control structure to move/adjust in response to, for example, a movement or signal from the control module. Examples include a rope which is connected to an actuator in the control module, and which can be pulled (or tensioned) or released by the actuator to move a control structure back and forward, a wire which is connected to a piezo electric actuator, or a shape memory alloy actuator wire. In these embodiments, the control module comprises at least one control actuator operably connected to the at least one linkage, the at least one control actuator being adapted to transmit power to the control surfaces through the at least one linkage.

The linkage may be a single component that extends from the control module to the control structure. Alternatively, the linkage may be formed of multiple components, such as a number of rods linked together and moveable together. The linkage may be releaseably attached to the control module so that it can be disconnected from the control module. Alternatively or in addition, the linkage may be releaseably attached to the airframe of the aircraft, so that the linkage may be separated from the airframe.

Thus, in one embodiment the at least one linkage comprises a line extending from the control module to the control structure. This provides a means by which energy can be transferred to the control structures to adjust the control structures.

The term “aircraft” incorporates aeroplanes and gliders. Thus, the aircraft may include a means for providing propulsion, such as a propeller or an on-board rocket (rocket booster). In other words, a built-in thrust or propulsion generator. In some embodiments, the means for providing the propulsion is integral to, or attached to the self-contained control module and can be releaseably connected to the airframe such that the means for providing propulsion can be removed from the aircraft together with the control module. Accordingly the means for providing propulsion can be re-used in a separate airframe. In other embodiments, the means for providing propulsion may be formed from disposable components (such as a propeller) and attached to the airframe, while being controlled by a motor located in the control module. For example, a shaft may extend from a motor in the control module and cause a disposable propeller located on the front of the aircraft to rotate.

The control module comprises the actuator(s) for controlling the control surface(s), and a controller for receiving position information and for producing a drive signal for controlling the actuator, optionally an electrical drive signal. The control module may also comprise all of the main control and guidance systems necessary to control and guide the aircraft to a target location, such as avionics, positioning and airspeed sensors and a power supply. These may include a microprocessor, memory, a power supply (e.g. a battery), a position detection module, sensors for detecting various parameters (such as airspeed, altitude, temperature), a wireless communications module and actuators in the form of servomechanisms. Additional components such as sensors, positioning beacons to facilitate location of the aircraft if it lands in a remote area and additional communications equipment may also be included in the control module. However, in some embodiments some of these may be mounted directly on the airframe. When mounted on the frame, the additional components may be provided as disposable, low-cost components. In an alternative embodiment, the control module comprises all of the electronic and/or electrical components.

Sensors used in the aircraft may include at least one, preferably a plurality, of the following: airspeed indicators, absolute altitude sensors, local height-above-ground sensors, attitude sensors for pitch and roll, an accelerometer, a positional sensor (for example, relative to the target location), groundspeed detection system, rate of descent/fall, or sensors for use in determining the position of the aircraft.

By controller it is meant that a part of the control unit is adapted to control actuation of components of the assembly, including adjustment of the control structure. The controller may be a separate component in the control unit, or it may be combined with other parts, for example in a single processor. The controller may be an electronic and/or electronic part.

Positional information comprises information regarding the location of the aircraft, for example, the aircraft's position relative to the target location. This may include receiving information from at least one of a Global Positioning Satellite (GPS) unit, a module capable of triangulating a position based on mobile telephone networks, a seeker for a laser designation system, a radio receiver that can be used as part of a twin-transmitter radio guidance system in which signal intensity and direction can be used to triangulate the assembly's position or receiver for a radio or IR beacon.

By self-contained it is meant that the control module is formed as a single unit in which the individual components of the control module are connected. In other words, the parts of the control module are held together and can be removed and inserted into the airframe as a single piece. In some embodiments, the control module may comprise a housing in which the components of the control module are housed. In some embodiments, the control module may comprise a housing and components of the control module may be housed within the housing and mounted on the outside surfaces of the housing. In an embodiment the control module may be formed of a number of modular components that are secured together to form a single unit. In this aspect of the invention, the self-contained control module comprises all of the electronic components required for control and flight of the aircraft. Thus, there are no electronic components (such as actuators, or motors) or located on any other part of the aircraft.

By “autonomous aerial delivery”, it is meant that the aircraft is capable of guiding itself to the target location, once the target location has been provided to the control module. The control module of the aircraft is able to steer the aircraft using the actuators to control the linkages and thus the control surfaces. In other words, an external pilot is not required to control the movement of the control surfaces.

The aircraft may be launched using a number of different launch methods. For example, it can be released from another aircraft (either from the hold or a compartment of another aircraft or it can be towed into the air by another aircraft) or it can be launched from the ground (surface-to-surface) using any suitable launch means, including the use of a lift-off rocket (a rocket booster that is temporarily used to lift the glider to an altitude at which it can glide to the target location) or the use of a sling or launching ramp.

In an embodiment, the aircraft comprises a plurality of control structures for controlling the flight of the aircraft and each of the plurality of control structures is operably connected to the control module by at least one linkage. Embodiments of the aircraft in which there are multiple control structures, each controlled by at least one linkage, have a high degree of control over the flight of the aircraft and therefore the aircraft can be accurately guided to the target location.

In another embodiment, the airframe further comprises at least one wing. In yet another embodiment, the airframe further comprises at least one deployable wing moveable between a stowed configuration and a deployed configuration. The stowed configuration is also referred to as a collapsed configuration. In a further embodiment, in the stowed configuration the at least one deployable wing provides a flight surface for producing lift having a first surface area; and in the deployed configuration the at least one deployable wing provides a flight surface for producing lift having a second surface area; the second surface area being larger than the first surface area. The flight surface is the area of the wing that is available (i.e. exposed) for providing lift. In other words, the area of the wing that is exposed in the deployed position, and is thus able to act as a wing and provide a means of maintaining flight (or slowing descent), is larger than when in the stowed configuration. For example, the wing will extend outwardly from the main body of the aircraft in the deployed position, but will be brought substantially against (or substantially within the footprint) of the main body in the stowed configuration. Thus, if the wing is completely retracted against or towards the main body, the first surface area will be substantially zero, or zero. Embodiments have the advantage of reducing the size requirements of the launch aircraft from which the aircraft according to the invention is delivered, since the footprint taken up by the aircraft is reduced by having the deployable wing(s) stowed away.

In another embodiment, the at least one deployable wing is moveable between the deployed configuration and a stowed configuration. Accordingly, the deployable wing can be re-stowed after the deployable wing has been deployed. In other words, the airframe can be collapsed back into its original collapsed configuration, for example after use. Where the airframe is to be reused, this allows it to be repackaged and conveniently stored or transported, e.g. on a pallet, and where the airframe is disposable, this may also assist in disposal and/or dismantling of the assembly.

In another embodiment, the control module is connected to the at least one deployable wing by a wing deployment mechanism and the control module is operable to move the wing from the stowed configuration to the deployed configuration using the wing deployment mechanism. The connection of the control module to the deployable wing provides an aircraft in which the wings can automatically be moved from a stowed position to a deployed position when required by the control module. This may be immediately on launch, or may be after a period of time or on detection of a specific parameter (e.g. airspeed or altitude). Thus, the aircraft can be adapted so as to automatically deploy the wing(s) at a point designated by a user. Such a wing deployment mechanism can be an electronic or electrical component (such as an actuator) located in or on the control module, or may be a mechanical (for example, spring loaded) mechanism controlled by the control module located in or on the control module, or mounted to the airframe.

This can assist in the launch of multiple aircraft from a launch aircraft simultaneously. For example, multiple aircraft according to the invention could be loaded onto a single pallet, which is facilitated by having the deployable wing(s) in the stowed configuration since the space occupied by each aircraft is reduced. The aircraft can then be launched in this configuration (i.e. from the pallet) without having to rearrange and deploy the wings of each aircraft prior to launch. Instead, the aircraft can be released from the launch aircraft and the wing(s) of each of the aircraft can automatically deploy once they are outside of the launch aircraft.

The wing deployment mechanism can be any suitable mechanical connection, such a linkage, a cog, a series of cogs or any other means of transferring kinetic energy from the control module to the at least one deployable wing so that the wing moves from the stowed (collapsed) configuration to the deployed configuration.

In another embodiment, the wing deployment mechanism comprises a wing deployment linkage and the control module comprises at least one wing deployment actuator operably connected to the wing deployment linkage, and the wing deployment actuator of the control module is adapted to adjust the at least one deployable wing using the wing deployment linkage so as to control the flight of the aircraft and to steer the aircraft to the target location. Thus, the wing deployment mechanism acts to both deploy the wing and to steer the aircraft, thereby acting as a linkage. This reduces the number of parts required in the control module and the airframe, together with the number of connections between the control module and the airframe and therefore may reduce the cost of manufacture and the burden on the user installing or removing the control module.

In another embodiment, the at least one deployable wing comprises the at least one adjustable control structure and the wing deployment mechanism comprises the at least one linkage. Embodiments thus provide an arrangement in which the linkage extends from the control module to the deployable wing(s) and can be used to deploy the wing(s) from the stowed position to the deployed position, while also being able to control the aircraft through the use of the control structure. This can reduce the number of actuators and mechanisms required in the control module thereby reducing the size and weight of the control module, as well as reducing the number of linkages.

In another embodiment, the at least one deployable wing comprises the at least one adjustable control structure. The control structure in this embodiment could be a part of the wing, such as an additional flap on part of the wing, or it could be the entire surface of the wing. In the latter arrangement, the linkage could move or bend the entire wing to control the flight of the aircraft. For example, the at least one linkage could be used to pulling the outermost end of the wing (wing tip) downwardly on one side to cause the aircraft to bank and therefore turn.

In another embodiment, the self-contained control module comprises a housing for receiving the actuators and the housing is sealed against ingress by water. In other words, the control module includes a sealed container or casing in which the components that do not need to be exposed and/or that may be damaged by the environment can be contained and protected. In some embodiments, parts of the control module, for example sensors, may be located on the outside of the housing. In an embodiment, all of the electronic components of the aircraft are contained within the housing of the control module. This will protect the control module both whilst in the aircraft and also once it has been removed. This is particularly advantageous if the control module is to subsequently be carried by a person or stored in an environment that may cause it to be damaged. In these embodiments, the housing may comprise apertures through which the linkages may extend. Alternatively, or in addition, connectors may extend from inside the housing to the outside so that the linkages may be attached to the connectors. In these embodiments, the apertures will be sealed against ingress by water so that the housing is sealed against ingress by water. In some embodiments, all of the components of the self-contained module will be contained within a housing.

In another embodiment, the control module further comprises a communications unit adapted to receive a signal identifying the target location from an external communications unit. The communications module may be wired or wireless. In some embodiments, the communications module may be a short-range wireless communications module. In these embodiments, a user could easily reprogram the target location to which the goods are to be delivered. If a wireless communications unit is used, a user may be able to reprogram a number of the control modules using a single command. In another embodiment, the communications unit can be a long-range wireless communications unit, which would allow the target location to be adjusted during flight, for example. This would be particularly advantageous where the goods were being delivered to a recipient that is mobile, for example, a person, as the destination could be adjusted. Examples of communications units include Bluetooth modules, infrared modules and USB connections and radio receivers and transmitters.

In another embodiment, the communications unit is further adapted to communicate with the communications unit of another aircraft. In this embodiment, when more than one aircraft is launched at a time, the aircraft can share information and data between one another, particularly if they are all proceeding to the same target location. This data can be a signal providing any sensed data, such as current location, temperature, airspeed, altitude, local height, conditions or other information such as target location, updated instructions. For example, if the airspeed or positional sensors on an aircraft are faulty or are inaccuracy, any other aircraft that have been launched to the same target location can share information such as the local airspeed and positional data to mitigate or eliminate the error. Of course, if there is more than two aircraft, this can be further mitigated by comparing the data of each of the aircraft. Such an arrangement of communications modules may also allow the use of an automatic prioritisation system. For example, if multiple aircraft are being dropped towards a number of homing beacons that are close together, a prioritisation system that communicates between the aircraft could be used to ensure that only one aircraft goes to each homing beacon, rather than all aircraft being directed to a single beacon. Another advantage of automatic inter-aircraft communication is that if several aircraft are flying towards the same target and one aircraft experiences difficulty, for example due to weather conditions or other issues at a particular location, the aircraft may be able to communicate a warning or information regarding the difficulties to the other aircraft. The other aircraft may then be able to avoid a problematic flight path by avoiding the location the first aircraft encountered difficulties.

In another embodiment, the airframe is formed of a biodegradable material; optionally the airframe consists essentially of a biodegradable material. By biodegradable, it is meant that materials can be decomposed by microorganisms, in particular by bacteria and especially by enzymatic action, leading to a significant change in the chemical structure of the material. For example, the biodegradable material may be paper, cardboard or any other woodpulp material; wood; canvas; cotton; biodegradable plastic (e.g. Polylactic acid); any other suitable biodegradable material or combinations thereof.

The invention in this embodiment provides an inexpensive and lightweight airframe providing means for containing and protecting the goods with a low environmental impact. Accordingly, the disposable airframe will not significantly damage the environment. Moreover, in an embodiment, the packaging can be manufactured from recycled materials thereby reducing the environmental impact further. In addition, in another embodiment the materials involved can be inexpensive and delivery can be achieved for significantly less. Further features, such as covering the airframe in a waterproofing material to protect the airframe structure can be included in the aircraft. In embodiments, the waterproofing material can be a wax, in particular a clean-burning wax or a polymer coating of nano-scale thickness, allowing the packaging to be safely burned. The term “nano-scale thickness” means a thickness of 1 nm to 10000 nm, preferably 1 nm to 1000 nm thick, more preferably 1 nm to 500 nm thick. For example, the polymer coating may be a hydrophobic polymer coating such as ethyl cellulose.

The term “consists essentially of . . . ” means that the airframe is almost entirely formed from a biodegradable material, but may contain minor quantities of other materials. For example, it may be formed from 85% or greater biodegradable materials (by weight or by volume), preferably 90% or greater, more preferably 95% or greater or even more preferably 99% or greater biodegradable materials.

Examples of linkages include cords or rigid rods. More particularly, linkages may be formed of cotton cord, jute or hemp ropes, a biodegradable polymer, a (thin) metallic wire (e.g. thin iron wire, which will rust), wooden dowels, metal members, or graphite rods. In an embodiment, the at least one linkage is formed of a biodegradable material, optionally the at least one linkage consists essentially of a biodegradable material. Accordingly the linkage(s) can be left to decompose with the airframe. This allows a user to safely discard the linkages after delivery of the goods. The linkages may be covered in a waterproof coating and may be formed of recycled materials.

In an embodiment, the control module further comprises a position detection module for detecting a position of the aircraft and for providing the position information to the controller. In a further embodiment, the position detection module comprises at least one of a satellite location unit and radio frequency detectors. A position detection module is any navigation system capable of determining the location of the aircraft, for example, the aircraft's position relative to the target location. In an embodiment, the position detection module comprises at least one of a Global Positioning Satellite (GPS) unit, a module capable of triangulating a position based on mobile telephone networks, a seeker for a laser designation system, a radio receiver that can be used as part of a twin-transmitter radio guidance system in which signal intensity and direction can be used to triangulate the aircraft's position or receiver for a radio or IR beacon.

In an embodiment, the aircraft is a glider. Thus, the aircraft does not require an on-board means of providing propulsion. In some embodiments, the aircraft may have a glide ratio of 3:1, 5:1 or preferably 10:1. That is to say, for every 10 units of distance the glider travels, the glider descends by 1 unit of distance. Embodiments thus provide a delivery system in which a low-cost aircraft can be produced. There is no requirement for potentially expensive propulsion systems, and both the cost of the airframe and the control module can be reduced. The use of a glider also reduces the complexity of the design of the aircraft and therefore makes it easier for a user at the target location to disassemble the aircraft after delivery (i.e. remove the control module). Further advantages include lower potential environmental impact as fuel or large batteries are not required to power the device. Furthermore, the equipment required to control the aircraft may be simpler, since there is no need to control the propulsion means.

In another embodiment, the airframe comprises a hold for receiving the load to be delivered. The hold may comprise a separate compartment in the main body for receiving the load, so as to avoid interference with the linkages by the goods and/or to protect the load from damage.

In another embodiment, the main body comprises at least one recessed portion adapted to at least partially receive the at least one deployable wing in the stowed configuration. Use of a recess or cavity to store the wing(s) in the stowed configuration can reduce the risk of damage to the wing(s), for example when loading and moving the aircraft. This can also reduce the footprint of the aircraft in its collapsed configuration and increase the stacking efficiency of the aircraft, for example by providing a substantially flat side. In an embodiment, the wing(s) are fully received into the recess.

In another embodiment, the main body further comprises at least one layer having a honeycomb structure, the honeycomb structure defining a cellular network extending in the plane of the layer for protecting the load that is to be delivered. The invention in this aspect further provides an effective way of protecting the hold. A honeycomb-structured layer has a structure that will protect the load in the main body and its structure can resist impact but also deform when the force reaches a threshold, thus allowing it to absorb the force of the impact and crumple. The use of a layer having a honeycomb structure further provides the advantage of improved safety by potentially reducing the damage to the landing zone and objects within the landing zone. In addition, the typical low cost nature of the cardboard honeycomb structures allows for its incorporation into a cheap and disposable airframe.

In another embodiment, propulsion and flight control may be effected through management of the boundary layer on the aircraft surfaces by drawing high pressure air of an aerofoil surface to the low pressure side of another aerofoil surface. This has the effect of modifying the lift performance of the aerofoil. By drawing air in this way either symmetrically or asymmetrically and imposing control on the amount of air drawn off through the use of a valve or valves contained within the control module, flight control may be effected. To draw the air of and deliver the air to another surface, the surfaces are perforated with microscopic holes through to a duct or ducts contained within the structure. The duct or ducts are connected to the control module where a corresponding control valve or valves (in other words, actuators) are located.

In another embodiment, the airframe is a disposable airframe.

### BRIEF DESCRIPTION OF THE DRAWINGS

Specific embodiments of the invention will now be discussed in detail with reference to the accompanying drawings, in which:

FIG. 1 shows a perspective view of an embodiment of the invention in a collapsed configuration;

FIG. 2 shows a perspective view of an embodiment of the invention in a deployed configuration;

FIG. 3 shows a control module in accordance with the invention;

FIG. 4 shows a perspective view of an embodiment of the invention in a collapsed configuration;

FIG. 5 shows a perspective view of an embodiment of the invention in a deployed configuration;

FIG. 6 shows a perspective view of an embodiment of the invention in a collapsed configuration;

FIG. 7 shows a perspective view of an embodiment of the invention in a deployed configuration;

FIG. 8 shows a perspective view of an embodiment of the invention in a collapsed configuration;

FIG. 9 shows a perspective view of an embodiment of the invention in a deployed configuration;

FIG. 10 shows a perspective view of an embodiment of the invention in a collapsed configuration;

FIG. 11 shows a perspective view of an embodiment of the invention in a deployed configuration;

FIG. 12 shows a perspective view of an embodiment of the invention in a deployed configuration;

FIG. 13 shows a perspective view of a part of an embodiment of the invention in a deployed configuration; and

FIG. 14 shows a plan view of an embodiment of the invention.

In the accompanying drawings, like reference numerals refer to like elements. For example, reference numerals 11, 111 and 211 refer to like elements.

### DETAILED DESCRIPTION

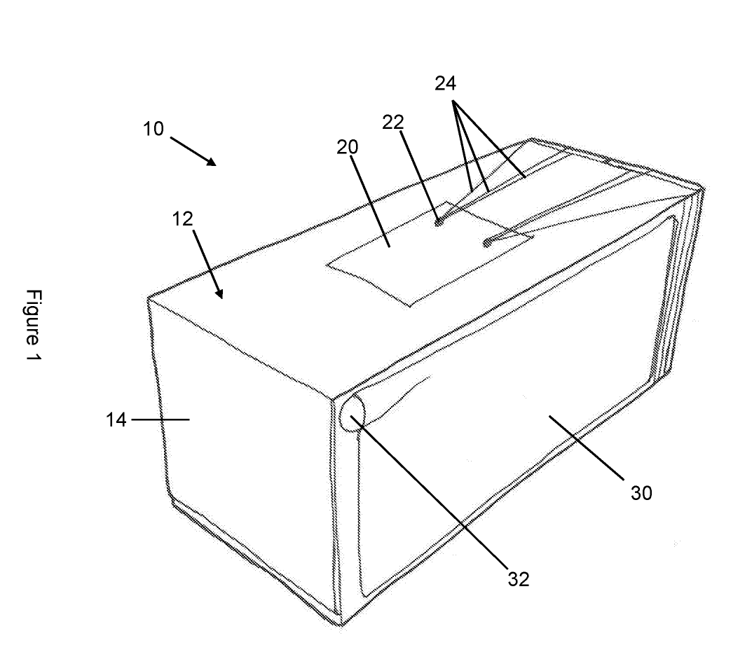

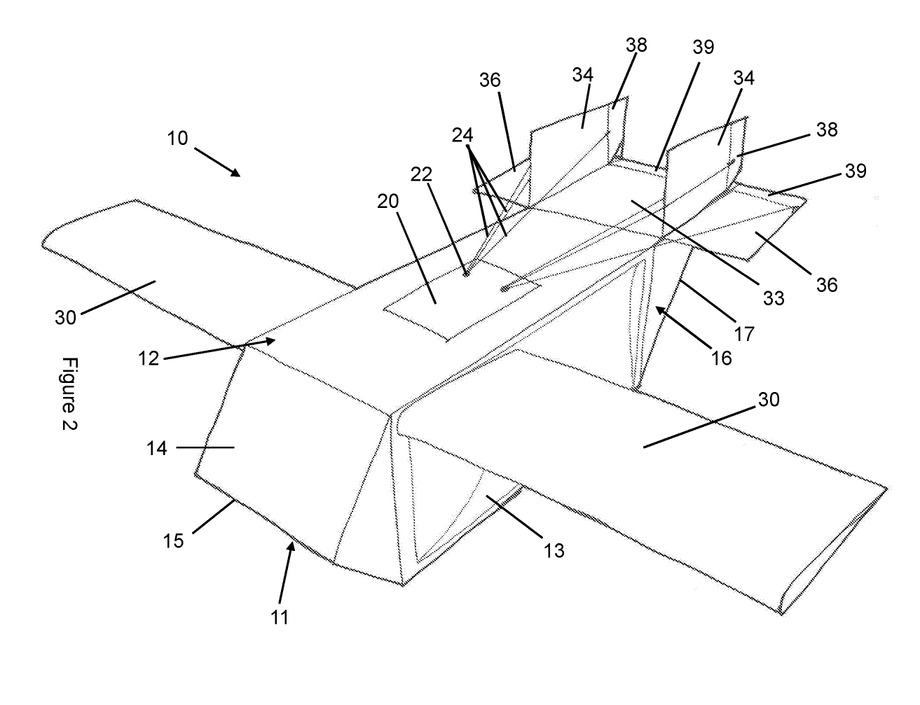

A first embodiment of the invention is shown in FIGS. 1 and 2 in the form of a glider 10. FIGS. 1 and 2 depict the glider 10 in a collapsed (or stowed) configuration and a deployed configuration, respectively. The glider 10 acts as a means by which goods can be delivered to a target located easily and at a low cost, as will be explained below. The glider 10 is initially stored in the collapsed configuration shown in FIG. 1 so that it can be efficiently packed, or stacked together with other such gliders, for example. The size of the glider in the collapsed configuration shown in FIG. 1 is approximately 500 mm×500 mm×1200 mm. When the glider is launched, it automatically deploys (as will be discussed in detail, below) into the deployed configuration shown in FIG. 2 thus providing all of the required components to allow the efficient aerial delivery of the goods stored within the glider 10.

In this embodiment, the glider 10 comprises an airframe, the airframe being formed from corrugated cardboard and comprising a main body 12 having a hollow interior (not shown), into which the goods to be delivered by the glider 10 can be received. The outer surface of the corrugated cardboard is coated with a clean burning wax, so as to protect the cardboard from water damage. The interior of the main body 12 of the airframe therefore acts as a hold for the goods. The interior (hold) of the main body 12 of the airframe is accessed through an opening (not shown) located on the underside of the airframe. The underside of the airframe is also reinforced with additional layers of cardboard, so as to protect the goods within the interior of the main body 12 as the glider lands.

As can be seen more clearly in FIG. 2, the airframe of the glider 10 also comprises two deployable wings 30, a nose or front section 11, a tail section 16 and a tail fin structure located on the tail section 16 comprised of two vertical stabilisers 34 and two horizontal stabilisers 36, The vertical stabilisers 34 and horizontal stabilisers 36 comprise moveable control surfaces 38, 39.

The two deployable wings 30 of the glider 10 in this embodiment are connected to the main body 12 of the airframe via a hinge connection 32. This connection takes the form a ball and socket type joint (with additional reinforcements, to maintain the wings 30 in connection with the main body 12), allowing rotation of each wing 30 in more than one plane. Accordingly the wings 30 can be rotated from the collapsed position shown in FIG. 1, to the deployed position shown in FIG. 2. The wings 30 in this embodiment are each spring-loaded by an internal spring in the hinge connection 32. The internal spring biases the wings 30 from the collapsed configuration to the expanded position so as to cause the wings 30 extend outwardly of the main body 12 and to form a wing structure capable of providing lift to the glider 10. The internal spring is of sufficient strength to overcome forces acting on the glider as it is deployed, such that the wings can deploy while in motion, such as during descent after release from another aircraft at altitude. The wings 30 are held in the collapsed configuration by a wing deployment mechanism, which comprises a wing deployment latch (not shown). The wing deployment mechanism is controlled by the control module 20, as will be discussed later. In the deployed configuration, the wings 30 open so as to extend outwardly from the top of the airframe. This arrangement improves the stability of the glider in flight.

As can be seen in more clearly in FIG. 2, the main body 12 of the glider 10 comprises two recesses, one located on either of the larger faces of the main body 12 from which the wings 30 extend in the expanded position. The recesses 13 are shaped and sized so as to receive the wings 30 therein in the collapsed configuration. Thus, when the wings 30 are folded down they are received into the recesses a substantially flush surface along the side faces of the main body 12. This reduces the risk of damage to the wings, reduces the footprint of the glider in its collapsed configuration and increases the stacking efficiency of the glider by providing a substantially flat side.

Each of the wings 30 has a standard wing structure in that they are shaped with a rounded leading edge (in cross section) and a sharp trailing edge (in cross section). The shape of each of the wings 30 means that the topside of each of the wings 30 provides a longer airflow path than the underside of each wing 30. As will be appreciated by the skilled person, when the glider is launched, this will provided lift to allow the glider 10 to glide to the target location. In this embodiment, the underside of each wing 30 is substantially flat. However, it will be appreciated that numerous wing designs could be used in conjunction with glider 10. The relatively straightforward wing structure design means that the wings 30 can be easily and cost-effectively manufactured from cheap and easy-to-use materials, such as cardboard.

At the rear of the glider is the tail section 16. As with the deployable wings 34, the tail section 16 is moveable between a collapsed configuration (FIG. 1) and a deployed position (FIG. 2), as will be explained below. The tail section 16 is comprised of a support surface 33, a rear panel 17 and side panels on either side of the tail section 16. The support surface 33 and rear panel 17 are formed of substantially rigid cardboard. The side panels are formed of a much thinner, flexible card, such that they can easily be folded. In the collapsed configuration, the tail section 16 is folded down so that it forms a substantially flat structure, which can be held against the rear of the main body 12. More particularly, the rear panel 17 is folded in on itself across its width and the support surface 33 is folded down so as to sandwich the rear panel 16 against the rear surface of the main body 12. The side panels are pre-formed with folding lines so as to cause them to fold down between the main body 12 and the support surface 33 in the collapsed configuration. In this way, the tail section 16 can be collapsed to reduce the area taken up by the glider 10. Furthermore, this reduces the risk of damage occurring to the tail section 16 when the glider 10 is being transported and/or packed prior to launch.

The tail section 16 is held in the collapsed configuration against a spring bias by a first latch (not shown). Thus, in order to convert the tail section 16 into the deployed configuration, the first latch is released and the resilient force forces the tail section 16 into the deployed configuration. The deployment mechanism also comprises a second latch, which is engaged in the deployed configuration. The second latch holds the tail section 16 in the deployed configuration.

In the deployed configuration, the support section 33 of the tail section 16 unfolds so to form a horizontal platform (horizontal when the glider 10 is horizontal). This platform serves to support the vertical stabilisers 34 and horizontal stabilisers 36. The rear panel 17 of the tail section 16 unfolds to form a support for the support surface which extends at an angle from the main body to the rearmost end of the support surface 33. The side panels of the tail section 16 unfold to extend between the main body 12, the rear panel 16 and the support surface 33. The resulting triangular shape formed by the rear panel 16 and the support surface also serves to improve the aerodynamic properties of the glider 10 by reducing drag acting on the glider 10 in flight.

The two vertical stabilisers 34 (or vertical tail fins) are each hingedly connected to the support surface 33 so that the vertical stabilisers can be moved from a configuration in which they are substantially flat against the surface of the support surface 33 (FIG. 1) and a configuration in which they are substantially perpendicular to the surface of the support surface 33 (FIG. 2). In the latter, deployed configuration the vertical stabilisers 34 are retained in the perpendicular, upright position by the use of a self-locking hinge joint (not shown); although it will be appreciated that any means by which the stabilisers 34 could be held in an upright position would be suitable. The use of the vertical stabilisers 34 in an upright position at the rear of the glider 10 improves the stability of the glider 10 in flight, as will be appreciated by the skilled person.

The vertical stabilisers 34 comprise moveable control surfaces 38 located at the rear of each of the vertical stabilisers 34, which act as rudders for controlling the glider's 10 horizontal pitch (yaw). The control surfaces 38 can also assist in the steering of the glider during flight by changing the aerodynamic properties of the stabilisers. In this embodiment, the moveable control surfaces 38 are provided as hinged sections of the vertical stabilisers 34, which sections can rotate relative to the main portion/section of the vertical stabilisers 34. Each of the vertical stabilisers 34 (including the moveable control surfaces 38) is made from a single (multi-layered) piece of corrugated cardboard, with the hinge connection between the main portion of the vertical stabilisers 34 and the moveable control surfaces 38 being formed by a preformed weakening or fold.

Like the vertical stabilisers, the two horizontal stabilisers 36 also move between a collapsed configuration and a deployed configuration by means of a hinge connection connecting the horizontal stabilisers 36 to the tail section 16. However, the horizontal stabilisers 36 move from a position in which the horizontal stabilisers are folded flat against the surface of the support surface 33 of the tail section 16 to a position in which they extend outwardly of the tail section in substantially the same plane as the support surface 33 (i.e. perpendicular to the sides of the main body 12). A rear portion of the horizontal stabilisers 36 forms a horizontal control surface 39. In this embodiment, the horizontal control surface 39 is formed so that it extends across the entire width of the tail section 16 and horizontal stabilisers 36 to form a single horizontal stabiliser 39, rather than a number of individually controlled stabilisers. Thus the glider 10 comprises a single, large horizontal control surface 39. As will be explained in more detail, below, this horizontal control surface 39 acts as an elevator and therefore controls the lateral attitude (pitch) of the glider, which allows the nose of the glider to be raised and lowered according to the arrangement of the horizontal control surface 39.

The front section 11 of the glider 10 comprises an upper front face 14 and a lower front face 15 and is moveable between a collapsed configuration (FIG. 1) and a deployed configuration (FIG. 2). In the collapsed configuration, the lower front face 15 is folded on itself across its width, so as to allow the upper front face 14 to fold into a position substantially flat against the front surface of the main body 12. In the deployed position, the upper and lower front faces 14, 15 are folded outwardly so as to form a triangular nose section 11. In other words, the upper and lower front faces 14, 15 are inclined relative to the front surface of the main body 12 and angled relative to one another to form a streamlined front section 11. As will be appreciated by the skilled person, in the deployed configuration, the front section 11 provides improved aerodynamic properties. The front section 11 also includes side panels which are pre-formed with folding lines so as to cause them to fold down between the main body 12 and the upper front face 14 in the collapsed configuration. As with the tail section 16, the front section is held in the collapsed configuration against a spring bias by a first latch (not shown). Release of the first latch allows causes the front section 11 to be expanded into the deployed configuration. The front section 11 is then held in the deployed configuration by a second latch.

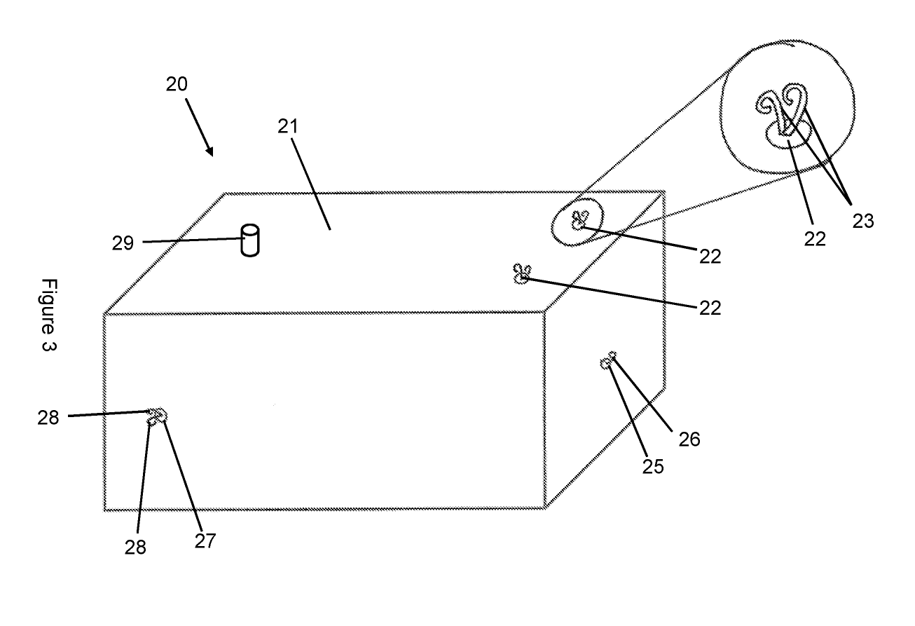

In addition to the airframe, the glider 10 also comprises a control module 20 housed within the main body 12 of the glider 10. This is show in more detail in FIG. 3. In this embodiment, the control module 20 is a completely self-contained unit housed in a damage-resistant plastic housing 21. The control module 20 houses all of the electronic components of the glider and comprises a number of electronic components including a microprocessor, memory, a battery, a GPS, sensors for detecting airspeed, direction of flight, attitude and altitude, a wireless communications module and a number of actuators in the form of servomechanisms.

In the glider 10, the control module 20 is received into an opening in the upper surface of the main body 12, but remains accessible. In this embodiment, the control module 20 comprises a lip (not shown) around its upper periphery that is larger than the opening in the upper surface of the main body 12. As such, when the control module 20 is inserted into the main body 12 the control module 20 remains located on the upper surface of the main body 12. The control module 20 can be held in place by any suitable means. This allows for the control module 20 to be easily accessed and also holds it in place relative to the main body 12.

In this embodiment, the control module comprises two self-sealing apertures 22 through which six hooks 23 extend (three hooks 23 per aperture). Only two hooks 23 per aperture 22 are shown in FIG. 3, for the sake of clarity. Each of the hooks 23 extends into the control module 20 through the aperture 22 and is connected to a separate servomechanism inside the control module 20. The other, exposed end of the hook connects to the end of one of six linkages 24 that extend from the control module 20 to the control surfaces 38, 39. In this embodiment, the linkages 24 each comprise a single length of biodegradable cord, and each linkage 24 is connected to a control surface 38, 39. In this embodiment, multiple linkages 24 are connected to a single control surface 38, 39. In particular, there are two linkages 24 connected to either side of each of the vertical control surfaces 38 of the vertical stabilisers and there are two linkages connected to the horizontal control surface 39. This arrangement allows for individual control of each of the control surfaces via the linkages 24. The apertures 22 are formed with a rubber seal that allows for movement of the linkages 24 but protects the inside of the control module from moisture ingress.

In this embodiment, the control module 20 of the glider 10 also comprises a two-part connection point 29 (not shown in FIGS. 1 and 2, visible in FIG. 3) on the upper, exposed surface of the housing 21 of the control module 20. The two-part connection point 29 is comprised of a first base section which is secured to the control module 20 and a second, releasable clip part that is releaseably mounted onto the first base part. The two parts of this connection point have electrical terminals mated with one another so as to maintain an electrical connection when the parts are connected. Once the second, releasable clip part is separated from the base part, this connection is terminated. This electrical connection can be arranged so as to only be activated once a user has activated the glider 10, ready for launch. The second, releasable part of the connection point is able to mate with the end of a static line via a static line clip.

The control module 20 further comprises two apertures 27 located on either side of the control module 20, which are not visible when the control module 20 is inserted into the airframe (one aperture 27 can be seen in FIG. 3). As with the apertures 22 on the top of the control module 20, the apertures 27 on the side of the control module 20 are self-sealing by means of a rubber closure having a self-sealing slit. Each of the apertures 27 on the side of the control module has two hooks 28 extending through it—one of the two hooks 28 on the side of the control module 20 being for attachment to a wing deployment linkage (not shown) and the other being for attachment to a control surface linkage (not shown). Both of the hooks 28 on either side of the control module 20 are connected to actuators to allow independent control of each of the linkages connected to the hooks 28 (one is connected to the wing deployment actuator).

The wing deployment linkage extends from the control module 20 to the latch holding the wings 30 in the collapsed configuration. When the wings 30 are to be deployed, the control module 20 will tension the wing deployment linkage, which causes release of the latch. This releases the wings 30, which under the spring tension, open up into the deployed configuration. The control surface linkage extends from the control module 20 to the tip of the wing (i.e. the outermost end of the wing) and is used to pulling the outermost end of the wing (wing tip) downwardly on one side to cause the glider 10 to bank and therefore turn.

The control module 20 further comprises apertures 25 located on its front and rear faces (only the aperture 25 on the rear face is shown in FIG. 3). Each of these apertures 25 has a single hook 26 extending therethrough, which is to be attached to a release linkage. The hook 26 located on the front face of the control module 20 connects to a release linkage which extends to the latch retaining the front section 11 in its collapsed configuration and the hook 26 on the rear face of the control module 20 connects to a release linkage which extends to the latch retaining the tail section 16 in its collapsed configuration. Both of the hooks 26 are connected to actuators in the control module 20.

In the control module 20, it will be appreciated that the hooks 23, 26, 28 are able to move in multiple directions. Thus, for example, the hooks 23, 26, 28 can extend out of their corresponding apertures 22, 25, 27 or be drawn back into the main housing 21 of the control module 20, with their corresponding linkages remaining attached.

In use, the glider 10 will be provided in its collapsed form, with the wings 30, front section 11, rear section 16 and stabilisers 34, 34 folded away so that the glider has a standard box-like shape. A user will then pack the goods to be delivered into the inner hollow of the main body 12 of the glider 10. Depending on whether the glider 10 has been provided with a control module 20 already fitted, the user may also be required to fit and connect the control module 20 to the glider 10. This would be the case, for example, if the control module 20 had been salvaged from another glider and is to be fitted to a glider airframe, as will be discussed later. Inserting the control module 20 comprises slotting the control module 20 into the opening in the upper surface of the main body 12 of the glider 10 and connecting the linkages 24 to the hooks 23 of the control module 20.

In this embodiment, prior to the launch of the glider 10, the user must input the target location to which the goods are to be delivered into the control module 20. This is achieved by wirelessly transmitting the target location to the wireless communications module of the control module 20. The glider is then ready to be launched.

The glider 10 of this embodiment is versatile in that there are a number of ways in which the glider 10 could be launched. One mode of launch for this embodiment is release of the glider 10 from a launch aircraft while the glider 10 is in its collapsed form. In particular, the glider 10 can be released from the rear door of an aeroplane in its collapsed configuration and can subsequently (automatically) deploy into the deployed configuration as it descends. The automatic deployment of the wings 30, stabilisers 34, 36, 38, 39, front section 14, 16 and tail section 16 can be achieved by a number of methods including through the use of a static line deployment mechanism that either physically releases latches to allow the deployable components to deploy or that activates the electrical switch connection point 29, through the use of sensors in the glider 10 that detect when the glider 10 has been launched, or through the use of a timer in the control module 20 that is activated by a user prior to launch, for example. In some embodiments, a combination of a number of these methods could be employed. In this embodiment, as described above, the control module 20 is specifically adapted for use with a static line deployment mechanism, and therefore this mode of deployment is preferred.

In the example of launch from a launch aircraft, once the glider is loaded onto the aeroplane, the connection point 29 of the control module 20 is connected to a static line, which itself is attached to a static line clip rail inside the aeroplane. This mode of deployment allows for the deployment of multiple gliders 10 simultaneously, since they can be stacked together on a single pallet in a similar fashion to the stacking of a normal pallet of boxed goods and each of the gliders 10 connected to a static line. To launch the glider(s) 10, either each glider can be released from the launch aircraft individually, or they can be launched simultaneously directly from the pallet.

As the glider 10 is released from the rear of the aeroplane and begins to descend, the static line remains tethered to the clip rail of the aeroplane and to the second, releasable clip part of the connection point 29. At the point where the static line is fully extended and tensed, the connection between the first base part and the second, releasable clip part is severed due to this being the weakest connection in the static line chain. This disconnection causes a signal to be transmitted to the microprocessor of the control module 20, which indicates that the glider 10 has been launched and is substantially clear of the aeroplane.

At this point, the control module 20 is entirely responsible for the controlling the flight of the glider 10. The control module 20, at the required time (e.g. based on sensed data or time since launch), will cause the wing deployment linkages and the release linkages to be actuated, so as to release the latches holding the wings 30, the front section 11 and the rear section 16 in the collapsed configuration. The control module 20 also actuates the linkages 24, causing the horizontal and vertical stabilisers 36, 34 to move to their deployed positions. The glider 10 is therefore in the deployed configuration shown in FIG. 2.

The microprocessor of the control module 20 acts as a controller and subsequently controls the flight of the glider 10 based on positional data received from the internal GPS module relative to the target location, together with any information, including flight speed, direction, attitude and altitude determined from the sensors located inside the control module 20. More particularly, on the basis of this information, the microprocessor causes actuation of the servomechanisms inside the control module 20 which causes tension or contraction in the required linkages 24 and subsequently causes movement of the control surfaces 38, 39. The control module 20 can also control the control surface linkage which extends from the control module 20 to the tip of the wing to cause the glider 10 to bank and turn. Of course, where there are multiple linkages 24 connected to a single flight surface, the microprocessor will cause the servomechanisms corresponding to each linkage 24 to work in unison. This provides a fully automated glider 10, which can steer itself to the target location.

Once the glider 10 reached its target location, it can land in a number of ways, dependent on how the user has programmed the glider 10, or on a number of detected parameters as the glider 10 approaches the landing site of the target location (e.g. altitude and air speed). In particular, if the landing site is not a purpose built site, the glider can be programmed to automatically choose the most appropriate landing sequence, dependent on its altitude as it approaches the target location. The control module 20 is able steer the glider 10 so as to cause the glider 10 to circle above the target location and slowly descend until it comes to a soft, controlled landing. Alternatively, the glider 10 begin descending gradually as it approaches the target location and either stall above the location or calculate the correct trajectory to allow it to land in a manner similar to traditional aeroplanes.

Alternatively, or in addition, the glider 10 can be fitted with a parachute so that, when the control module 20 detects that the glider 10 is approaching the target location, the control module 20 causes the parachute to deployed causing the glider to slowly drop to the target location. This can be achieved using an additional linkage that connects the control module to a parachute deployment module. The parachute module can cause the parachute to be deployed by any known parachute deployment method, such as through the use of a drogue parachute. If a parachute is employed, the parachute used can be a biodegradable or recyclable parachute so as to avoid requiring the parachute to be recovered and to reduce the environmental impact of using a parachute.

Once the glider 10 has landed, the recipient is able to remove both the goods from the inner hollow of the main body 12 and the control module 20. Removal of the control module 20 requires disconnection of the linkages 24 from the control module 20 by removing the linkages from the hooks 22, 26, 28 or severing the linkages along their length. As all of the electronic components of the glider, including the servomechanisms, are held in the self-contained control module 20, removal of the control module 20 allows the most expensive and the reusable parts of the glider 10 to be salvaged from the glider 10. These can subsequently be re-used in a new glider 10 airframe.

Once the control module 20 has been removed, all that remains is the cardboard airframe of the glider 10 and the biodegradable linkages 24. Accordingly, all of the components that remain can be easily and safely disposed of by either being left to biodegrade, be recycled or be safely burnt and therefore have a minimal impact on the environment, particularly compared to the aerial delivery systems of the prior art. Furthermore, the materials used make the glider 10 cheap enough to manufacture that it can be single-use without the glider 10 being an inefficient use of resources or harmful to the environment.

Accordingly, the invention in this embodiment provides a glider 10 that is fully autonomous in flight and can be easily stacked and packed. The control module 20 of the glider is able to steer the glider 10 to arrive at its location, with the contents of the goods fully intact. The use of a glider instead of an existing air drop system enables a much larger range to be covered than would otherwise be possible, since the aircraft that the glider 10 is launched from does not have to be directly above the target, and instead can be miles away from the target location. Compared to existing methods of aerial delivery, this also means that the aircraft from which the glider 10 is launched does not need to fly over the target location, which in hostile environments such as a warzone reduces or eliminates the risk of the aircraft from which the glider 10 is launched being shot down. Further, compared to transporting the goods in a transport aircraft, it avoids the need for the aircraft to land at the site, which can improve safety (e.g. in a hostile environment), or simply lead to a more efficient delivery meaning a saving in time and costs.

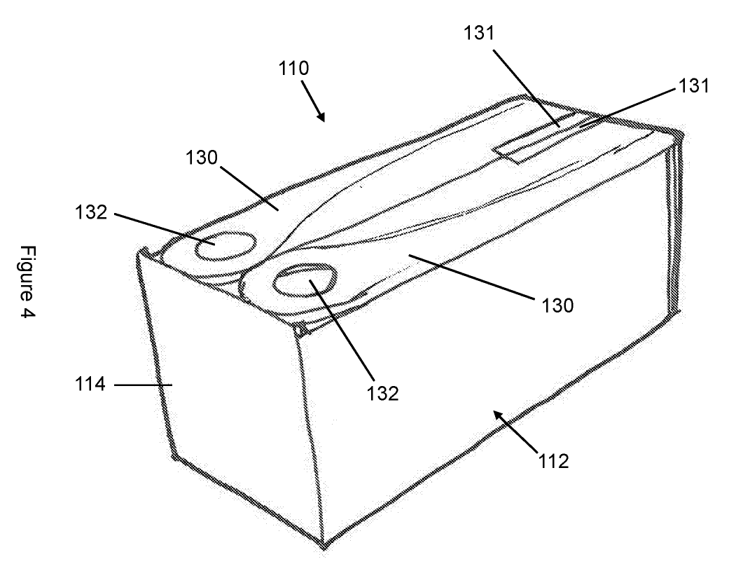

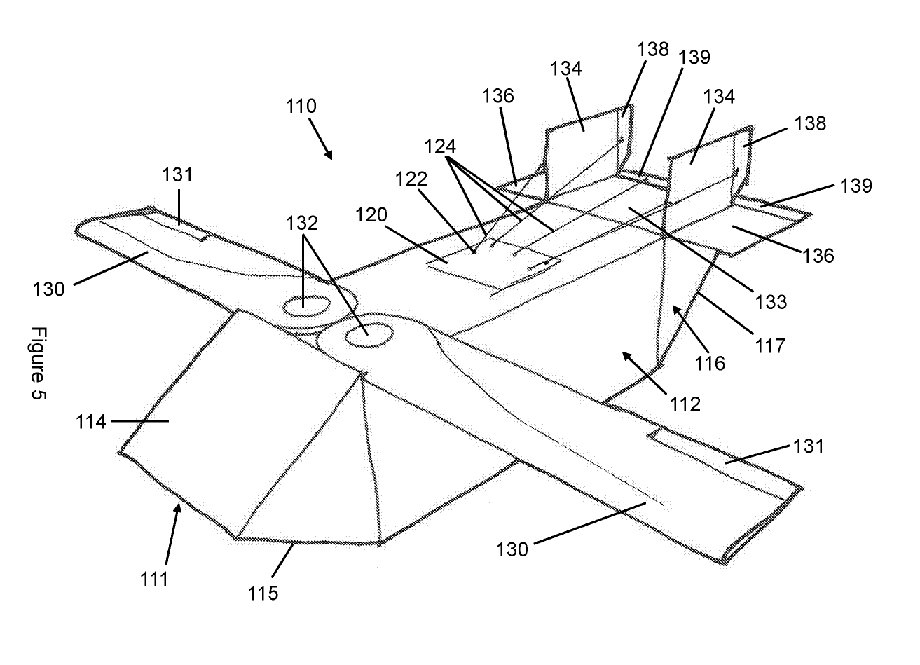

Another embodiment of the invention is shown in FIGS. 4 and 5. As with the embodiment of FIGS. 1 and 2, this deployable glider 110 comprises a main body 112 comprising wings 130, a tail section 116, a front section 111 and vertical and horizontal stabilisers 134, 136. The glider 110 also comprises a control module 120, which is connected to flight control surfaces 138, 139 via a plurality of linkages 124. The flight control surfaces 138, 139 form part of the vertical and horizontal stabilisers 134, 136 and are controlled by the control module 120 via the linkages 124.

As with the embodiment of FIGS. 1 and 2, the control module 20 houses all of the electronic components of the glider in this embodiment and comprises a number of electronic components including a microprocessor, memory, a battery, a GPS, a number of sensors, a wireless communications module and a number of actuators in the form of servomechanisms. The control module 120 also controls the deployment of the glider 110 from its collapsed configuration (shown in FIG. 4) to its deployed configuration (shown in FIG. 5).

One way in which this embodiment differs from the embodiment of FIGS. 1 and 2 is the attachment of the linkages 124 to the control module 120. In this embodiment, the linkages 124 are attached to the actuators of the control module 120 within the housing of the control module 120. Thus, they are not readily releasable from the control module, without opening the housing of the control module 120. The linkages 124 are instead intended to be removable from the airframe of the glider 110 and therefore are releaseably attachable to the control surfaces 138, 139 on the airframe, by a releasable connection to connectors (not shown) located on the control surfaces 138, 139.

Another way in which this embodiment differs from the embodiment of FIGS. 1 and 2 is the design of the wings 130. This embodiment uses a “swing wing” design. In other words, each of the wings 130 is rotatably mounted on the main body 112 so as to be able to rotate in a single axis about a pivot 132 from a collapsed configuration shown in FIG. 4, to the deployed position shown in FIG. 3. In this embodiment, the wings 130 and pivots 132 are located on the upper surface of the main body 112.

The rotation of the wings 130 from the collapsed configuration (FIG. 4) to the deployed configuration (FIG. 5) is achieved through the use of wing deployment linkages (not shown) which extend from a spool (not shown) in the control module 120 to the front of the main body 112 and through each of the wings 130. Each spool in the control module 120 can be rotated by a motor allowing the wing deployment linkages to be wound onto and off the spool, as required, which controls the configuration of the wings 130.

More particularly, each of the wing deployment linkages extends from the control module 120, around one of the pivots 132 of a wing 130 and into the wing 130. One end of the wing deployment linkages is connected to the control module 120 and the other end is releaseably connected to the inner edge of each wing 130 towards the tip (i.e. the part of the wing that faces rearwardly in the deployed position, at a point located away from the pivot 132). In this way, the pivot 132 also acts as a fixed wheel of a pulley system by allowing the wing deployment linkage to partially loop around it and extend into the wing 130. Accordingly, when the wings 130 are in the collapsed configuration, the control module 120 can tension and pull the wing deployment linkage through rotation of its corresponding spool, which due to the arrangement of the wing deployment linkages about their respective pivots 132, pulls the tip of the wings 130 forward and into the deployed position.

The wings 130 of this embodiment also comprise ailerons 131 located towards the tip of the wings 130 on the rear edge, as can be seen in FIG. 5. The ailerons 131 are hingedly attached to the wings 130 and can move relative to the wings 130. This allows for control of the flight path of the glider 110, since the ailerons 131 can be used to control the profile of the surfaces of the wings 130 and therefore banking and rolling of the glider 110 can be controlled. As with the flight control surfaces 38, 39 of the embodiment of FIGS. 1 and 2, the ailerons are formed in this embodiment as a preformed flap in the wing structure, made from the same material as the wings 130.

In use, the glider 110 functions in a similar manner to that of FIGS. 1 and 2 and can be launched by any number of methods and land in a number of ways.

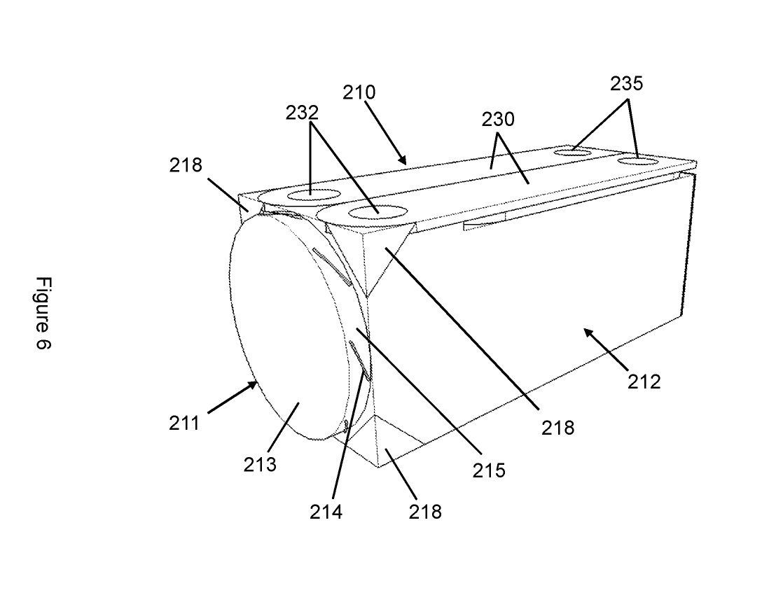

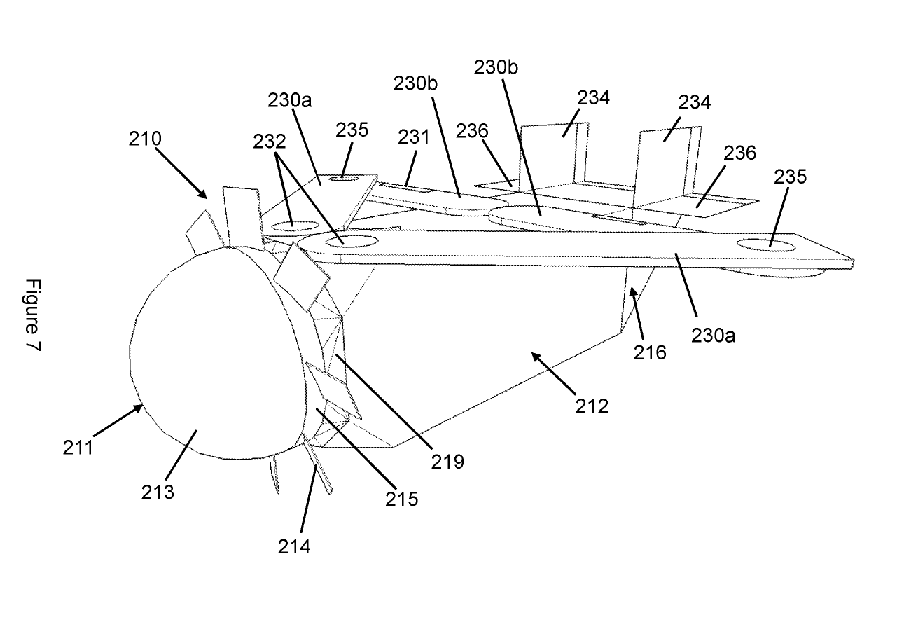

A third embodiment of the invention is shown in FIGS. 6 and 7. The aircraft 210 of this embodiment has a similar basic structure to the previous embodiments in that it comprises a main body 212, wings 230a, 230b, a tail section 216, a hold for goods (not visible), a control module and linkages. The main differences between this aircraft 210 and the gliders 10, 110 of the previous embodiments are the provision of propulsion means in the form of a deployable propeller 211, an internally mounted control module (not visible), internally mounted linkages (not visible) and the wing 230a, 230b structure.

The control module in this embodiment is housed within the main body 212 of the airframe so that it is not visible in normal use. It can be inserted into and removed from the main body via an access panel (not visible). Linkages extend from the control module to the control surfaces and the wing deployment mechanisms internally, within the airframe. This reduces the risk of a linkage becoming snagged or damaged. In this embodiment, the linkages are biodegradable and are not removed from the airframe once the aircraft has reached its target location. Instead, the linkages are releaseably connected to the control module. This reduces the assembly time required to insert a control module into the airframe.

The aircraft 210 comprises deployable wings 230a, 230b provided in a scissor-wing arrangement. In this arrangement, each wing is formed of a front section 230a, which is pivotally connected to a main body 212 of the aircraft via pivot 232, and a rear section 230b, which is pivotally connected to the front wing via pivot 235 and the main body by another pivot (not visible). The wings 230a, 230b in this arrangement are moveable from the collapsed position shown in FIG. 6 to the deployed position shown in FIG. 7. The wings 320a, 320b are also provided with ailerons 231 on the rear section 320b, which assist in control of the flight of the aircraft 210. Further control surfaces are provided on the rear tail section 26, which has vertical and horizontal stabilisers 134, 136, each of which comprises control surfaces which can be controlled by the control module via the internal linkages.

The deployable propeller 211 comprises a flexible front section 213, a number of propeller blades 214 and a rigid frame 215, around which the front section 213 is stretched and through which the propeller blades 214 extend. The propeller blades 214 are biased inwardly, so that when no outward force is exerted on them, the blades 214 are retracted. Thus, the blades 214 only deploy as the frame 215 and front section 213 rotate, due to centripetal force. This improves the gliding properties of the aircraft 210, as the additional drag caused by the propeller blades 214 is reduced when the propeller 211 is not being rotated. Rotation of the propeller 211 is achieved by a motor housed in the control unit. In particular, the propeller 211 is connected to the motor via a rigid member, such as a metal rod, which extends from the propeller 211 and into the control unit.

As shown in FIG. 6, the deployable propeller 211 can be provided in a collapsed form in which the propeller blades 214 are retracted and in which the flexible front section 213 provides a flat surface on the front of the aircraft 210. From this position, the deployable propeller 211 can be inflated using a gas generation means (for example, CO₂) to create the dome-like structure shown in FIG. 7, Optionally the aircraft 210 may include an additional foaming means to provide the flexible front section 213 with a rigid foam structure, which maintains the flexible front section's 213 shape in the deployed configuration, Furthermore, during the deployment of the flexible front section 213, protective corners 218 provided on the main body 212 covering the front corners of the main body 212 are prised off and the rigid frame 214, which is connected to the main body 212 via a flexible collar 219 (only visible in FIG. 7), is moved forward. This exposes the flexible collar 219, which takes the form of an aerodynamic section, caused by a sub-structure beneath the collar, which, together with surfaces previously covered by the protective covers 218 improves the aerodynamic properties of the aircraft 212.

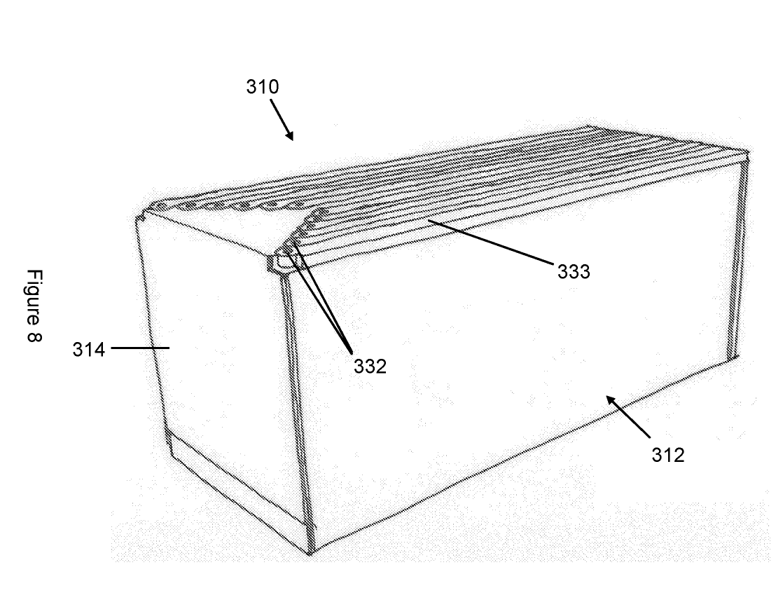

Fourth and fifth embodiments are shown in FIGS. 8 and 9 and FIGS. 10 and 11, respectively. These embodiments show gliders 310, 410 having alternative wing structures.

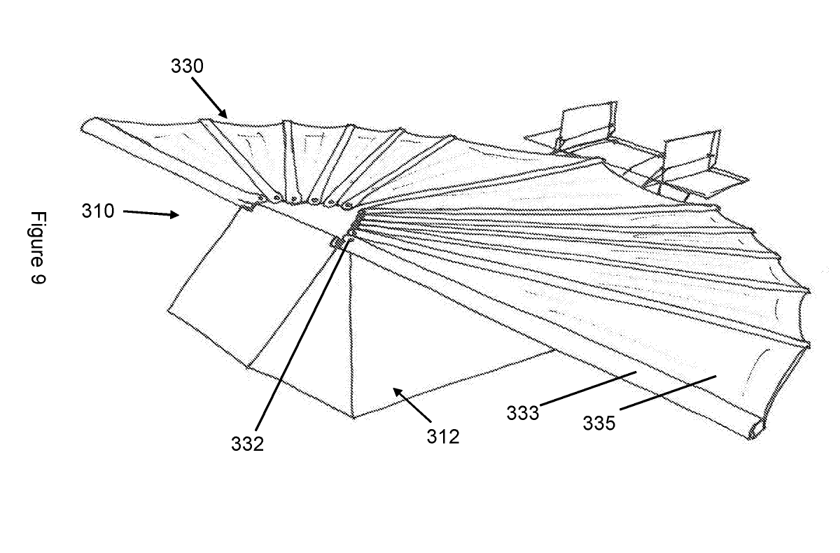

In the embodiment of FIGS. 8 and 9, the glider 310 has a similar structure to the embodiments of FIGS. 1 and 2 and FIGS. 4 and 5, except that it comprises a fan wing structure 310. As with the previous embodiments, the glider 310 can move between a collapsed configuration (FIG. 8) and an expanded, deployed configuration (FIG. 9).

The fan wing 330 of the glider 310 is a single wing formed of a number of ribs 333 having material 335, in this case a nylon sheet, extending between each of the ribs. The ribs 333 are each attached to a main body 312 of the glider 310 at its forward end via pivots 332. The pivots 332 allow the ribs 333 to rotate, thus allowing the fan wing 330 to rotate between the collapsed form shown in FIG. 8 to the expanded form shown in FIG. 9. The ribs 333 in the collapsed form serve to protect the nylon material from damage.

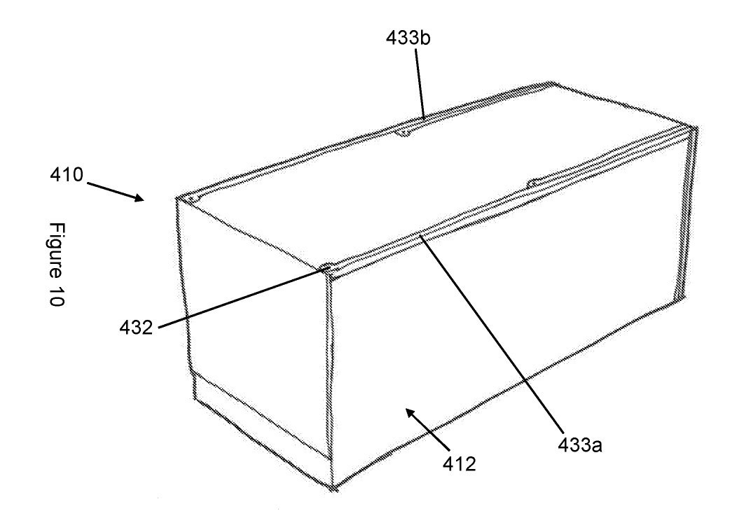

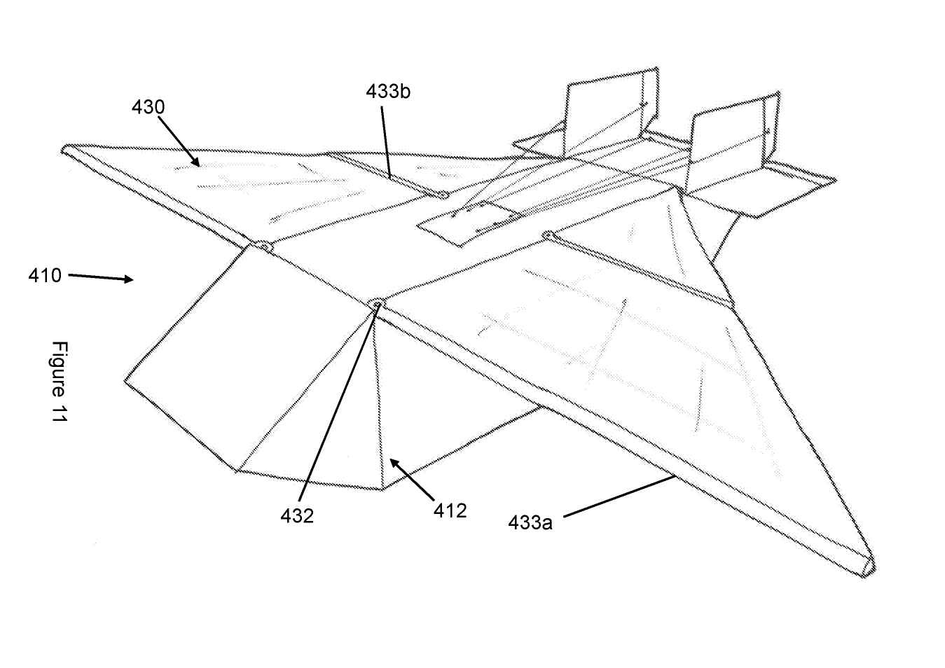

In the embodiment of FIGS. 10 and 11, the glider 410 also comprises a fan wing 430, but with a different structure. Instead of having a large number of ribs, as in the embodiment of FIGS. 8 and 9, the glider 410 comprises separate wings 430, each having a large wing member 433a and a small wing member 433b. The members 433a, 433b are each attached to a main body 412 of the glider 410 via pivots 432. The pivots 432 allow for rotation of the members 433a, 433b between the collapsed form shown in FIG. 10 to the expanded form shown in FIG. 11.

Although in the above embodiments, the tail sections 16, 116 and front sections 11, 111, 211 are components that can be converted from a collapsed configuration to a deployed configuration. However, in alternative embodiments, the tail and nose sections may not be deployable parts of the aircraft. In other words, they may be fixed components that are formed in the equivalent configuration to the deployed configuration of the above embodiments. These may be in the form of nose sections and tail sections that are either integral to the main body of the aircraft or that are separate sections which can either be mounted onto the main body, or are provided in the form in which the aircraft is flown. In other embodiments, the nose section and/or tail section may be omitted from the aircraft design.

Furthermore, although all the above embodiments comprise deployable wings, it is not required that this is the case. Instead, the wings may be provided as fixed wings. Alternatively, other wing deployment methods could be employed in an aircraft falling within the scope of the invention, including inflatable wings, for example.

In the above embodiments, the linkages 24, 124, 224 which control the control surfaces 38, 39, 138, 139, 238, 239 extend from their respective control modules external to the main body of their respective airframes. However, in alternative embodiments, the linkages 24, 124, 224 may contained solely within the airframe. Similarly, any of the linkages used in the aircraft may be either internal or external to the airframe of the aircraft.

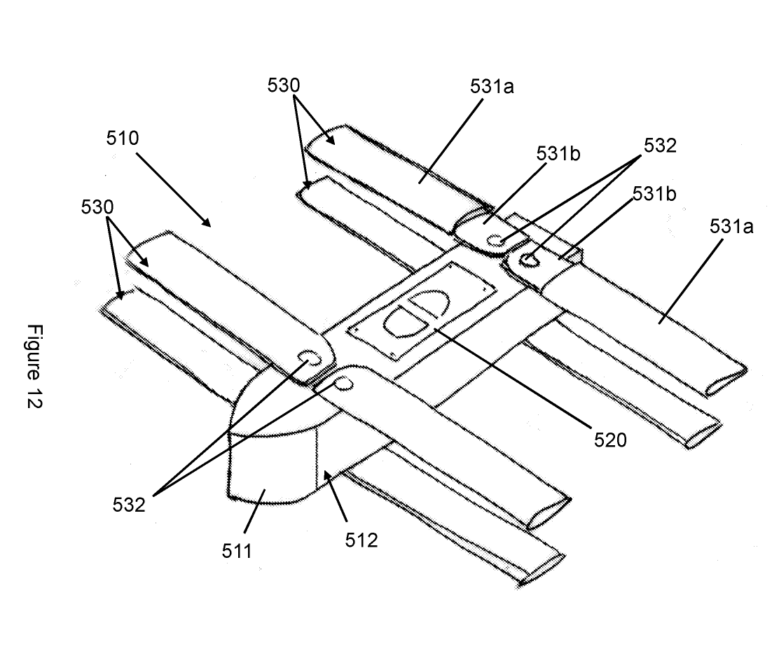

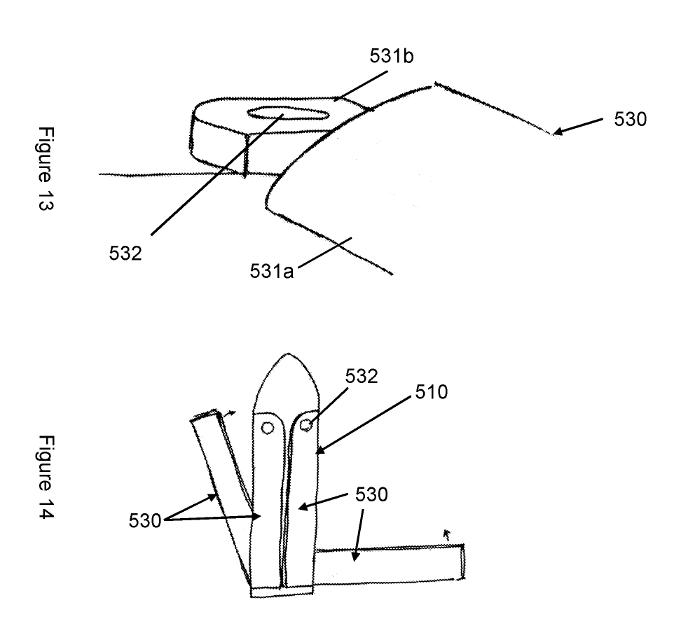

Another embodiment of the invention is shown in FIGS. 12 to 14. In this embodiment, the glider 510 has a particularly streamlined body 512 having at its front end a pointed nose 511 having rounded surfaces for improved aerodynamic properties and a control unit 520 received in a central recess provided in the main body 512. The control unit 520 is used to control the flight of the glider 510 and the deployment of the wings 530 via linkages (not shown) which extend between the control unit and the wings 530. However, in this embodiment, the linkages are hidden within the body 512 and wings 530 of the glider 510, rather than being external to the body 512.

The glider 510 also differs from the previous embodiments in that it comprises multiple individual wings 530, which are arranged in two different planes extending along the length of the glider 510. As such, the eight individual wings 530 form two sets of four wings 530, wherein each set comprises one pair of wings 530 located directly above the other pair of wings 530, in a similar fashion to a biplane wing arrangement. This arrangement provides a large amount of wing surface area without requiring an excessively large wing span.

Each of the wings 530 is rotatably mounted to the main body 512 by a pivot 532 and can rotate between a stowed position and a deployed position (see deployed position in FIG. 12). In the stowed position (see a partially stowed position shown in FIG. 14), the wings 530 mounted on the front of the upper surface of the main body 512 overlay the wings 530 mounted on the rear of the upper surface of the main body 512. In the deployed position, a locking mechanism (not shown) can be used to hold the wings 530 in their deployed positions. The glider 530 is also adapted such that after deployment of the wings 530, the locking mechanism (if present) can be released to allow the wings 530 to be rotated back about the pivots 532 into the stowed position (see the partially stowed position in FIG. 14).

In this embodiment, the flight control surfaces are provided in the form of the wings 530 mounted on the upper rear surface of the main body 512. These wings 530 are formed of two parts—a mounting portion 531b, which is mounted on the main body 512 via the pivot 532 about which the wing 530 can rotate, and a guidance portion 531a, which is connected to the mounting portion 531b via a rod (not shown) extending through both the mounting portion 531b and the guidance portion 531a. The guidance portion 531a is rotatable to the mounting portion 531b about the central axis of the rod (i.e. it can rotate about a central axis extending in the elongate direction of the wing 530 (and thus the guidance portion 531a)) and the guidance portion 531a of each of the upper, rear wings 530 can rotate independently of the guidance portion 531a of the other upper, rear wing 530. Through the rotation of the guidance portion 531a relative to the mounting portion 531b, the flight of the glider 530 can be controlled.

As will be appreciated, this particular wing structure (comprised of a mounting portion and a guidance portion) could be applied to any assembly in accordance with the invention, and does not require the particular wing or body arrangement provided in the embodiment of FIGS. 12 to 14. In a further embodiment, the guidance portion may be rotatable relative to the mounting portion is more than axis, so as to provide more control over the flight of the glider.

As mentioned above, there are numerous ways in which aircraft according to the invention may be launched. For example, the aircraft may be released from another aircraft (either from the hold or a compartment of another aircraft or it can be towed into the air by another aircraft) or it can be launched from the ground (surface-to-surface) using any suitable launch means, including the use of a lift-off rocket (a rocket booster that is temporarily used to lift the aircraft to an altitude at which it can fly to the target location). In any of the above methods of launch, the aircraft may be deployed either prior to launch, during launch or after launch; however, some launch methods may be particularly suited to particular configurations of the aircraft.

The control modules 20, 120, 220 in the above embodiments comprise a similar structure. However, it will be appreciated by the skilled person that the control modules may have any structure suitable to control the flight of the aircraft through the use of actuators but may include additional components for any other purpose. For example, the control module may include camera modules for taking aerial photos or additional sensors for data gathering. Alternatively, the control module could have a more simplistic form and include some logic units rather than processors, which may reduce costs.

In the above embodiments, the airframes of the aircraft have corrugated cardboard frames, which may be reinforced. Reinforcement can be achieved using additional or thicker layers of the material from which the aircraft are constructed. Additionally, or alternatively, there may be specific impact absorbing materials, such as honeycomb structured cardboard, or foam. This can be used to reduce the impact of landing and protect the contents of the aircraft. As the airframe is disposable, it is no consequence if the reinforcement is damaged upon the aircraft landing, since it will not be recovered. Alternatively, or in addition, the aircraft may also comprise wheels on its underside to assist in landing.

Other variations to the disclosed embodiments can be understood and effected by those skilled in the art in practicing the claimed invention, from a study of the drawings, the disclosure, and the appended claims. For example, in the examples above:

the airframe of the aircraft is manufactured from corrugated cardboard, however, the airframe may be manufactured or contain parts made from any suitable material such as plastics, cardboard (corrugated cardboard, cardboard sheets, honeycomb cardboard (for example, as an impact absorbing base or side for protecting the goods in the main body of the aircraft), fibreglass, wood, metals (aluminium, for example) or combinations thereof; preferably the airframe is manufactured from cardboard or any other wood pulp material; cellulose; biodegradable plastic such as Polylactic acid (PLA); or any other biodegradable material, or combinations thereof;

the hinges between the moveable parts, such as the control surfaces of the aircraft may be formed of any suitable hinge, for example the hinge may be a separate component, the joint may be reinforced (for example using resilient biodegradable plastics, for example), or the hinge may be integral to the surfaces from which the control surfaces are formed; the propeller of the third embodiment is shown as an inflatable propeller, however, any propulsion means can be employed, and indeed the propeller can be any propeller design, including any deployable/collapsible propeller;

the control module housing can be manufactured from a number of materials including metals (such as aluminium or steel) or plastics (PVC, PET) and may be coated in other materials; and

the attachment means by which the linkages attach to the control module (described in the above embodiments as “hooks”) can be any suitable attachment means such as clips, eyelets, screw-thread connecters, magnets and is preferably (but not necessarily) releasable (without destruction of the linkage or connector).

1. An aircraft for the autonomous aerial delivery of a load to a target location, the aircraft comprising:
an airframe having at least one adjustable control structure for controlling the flight of the aircraft and a main body adapted to receive a load;
a self-contained control module releaseably connected to the airframe, the control module containing an actuator for adjusting the control structure and a controller for producing a drive signal for controlling the actuator; and
at least one linkage extending from the control module to the at least one adjustable control structure so as to operably connect the control module to the at least one adjustable control structure,
wherein the actuator of the control module is adapted to adjust the at least one adjustable control structure using the at least one linkage so as to control the flight of the aircraft and to steer the aircraft to the target location.

2. The aircraft of claim 1, wherein:
the aircraft comprises a plurality of control structures for controlling the flight of the aircraft; and
each of the plurality of control structures is operably connected to the control module by at least one linkage.

3. The aircraft of claim 1, wherein the airframe further comprises at least one deployable wing moveable between a stowed configuration and a deployed configuration.

4. The aircraft of claim 43, wherein:
in the stowed configuration the at least one deployable wing provides a flight surface for producing lift having a first surface area; and
in the deployed configuration the at least one deployable wing provides a flight surface for producing lift having a second surface area;
the second surface area being larger than the first surface area.

5. The aircraft of claim 3, wherein the control module is connected to the at least one deployable wing by a wing deployment mechanism and the control module is operable to move the wing from the stowed configuration to the deployed configuration using the wing deployment mechanism.

6. The aircraft of claim 5, wherein:
the wing deployment mechanism comprises a wing deployment linkage and the control module comprises at least one wing deployment actuator operably connected to the wing deployment linkage, and
the wing deployment actuator of the control module is adapted to adjust the at least one deployable wing using the wing deployment linkage so as to control the flight of the aircraft and to steer the aircraft to the target location.

7. The aircraft of claim 3, wherein the at least one deployable wing comprises the at least one adjustable control structure.

8. The aircraft of claim 1, wherein the self-contained control module comprises a housing for receiving the actuators and the housing is sealed against ingress by water.

9. The aircraft of claim 1, wherein the control structure is a control surface.

10. The aircraft of claim 1, wherein the at least one linkage comprises a line or member extending from the control module to the control structure.

11. The aircraft of claim 1, wherein the control module further comprises a communications unit adapted to receive a signal identifying the target location from an external communications unit, optionally wherein the communications unit is a long-range wireless communications unit.

12. The aircraft of claim 11, wherein the communications unit is further adapted to communicate with the communications unit of another aircraft.

13. The aircraft of claim 1, wherein the airframe is formed of a biodegradable material, optionally the airframe consists essentially of a biodegradable material.

14. The aircraft of claim 1, wherein the at least one linkage is formed of a biodegradable material, optionally the at least one linkage consists essentially of a biodegradable material.

15. The aircraft of claim 1, wherein the control module further comprises a position detection module for detecting a position of the aircraft and for providing the position information to the controller.

16. The aircraft of claim 15, wherein the position detection module comprises at least one of a satellite location unit and radio frequency detectors.

17. The aircraft of claim 1, wherein the aircraft is a glider.

18. The aircraft of claim 1, wherein the control module comprises a propulsion generation means for providing thrust to the aircraft during flight.

19. The aircraft of claim 1, wherein the at least one linkage is releaseably connected to the control module.

20. The aircraft of claim 1, wherein the main body comprises at least one recessed portion adapted to at least partially receive the at least one deployable wing in the stowed configuration.

21. The aircraft of claim 1, wherein the main body further comprises at least one layer having a honeycomb structure, the honeycomb structure defining a cellular network extending in the plane of the layer for protecting the load that is to be delivered.

22. Use of the aircraft of claim 1 to deliver a load to a target location.
